(19) United States
(12) Patent Application Publication
(10) Pub. No.: US 2025/0170702 A1
(43) Pub. Date: May 29, 2025

(54) DEVICE AND SYSTEM FOR GENERATING OR ASSISTING A RELATIVE MOVEMENT BETWEEN BODY PARTS CONNECTED TO ONE OTHER VIA AN ARTICULATED STRUCTURE

(71) Applicant: PIERBURG GMBH, NEUSS (DE)

(72) Inventors: FELIX STRACKE, NEUSS (DE); JAVIER GONZALEZ CARRACELAS, NEUSS (DE); MIRA SCHUELLER, NEUSS (DE); TOBIAS STAPELS, NEUSS (DE)

(73) Assignee: PIERBURG GMBH, NEUSS (DE)

(21) Appl. No.: 18/842,395

(22) PCT Filed: Mar. 1, 2022
(86) PCT No.: PCT/EP2022/055050

§ 371 Date: Aug. 29, 2024

(51) Int. Cl. B25J 9/00

(52) U.S. Cl. CPC B25J 9/0006

(57) ABSTRACT

A device for generating or assisting a relative movement between two body parts which are connected to one another via a joint structure. The device includes a first load-bearing structure which is attached to a first body part of the two body parts, a second load-bearing structure which is attached to a second body part of the two body parts, and an actuator. The second body part is pivotable relative to the first body part. The actuator connects the first load-bearing structure to the second load-bearing structure. The actuator is an electrostatic linear film actuator.

### CROSS REFERENCE TO PRIOR APPLICATIONS

This application is a U.S. National Phase application under 35 U.S.C. § 371 of International Application No. PCT/EP2022/055050, filed on Mar. 1, 2022. The International Application was published in German on Sep. 7, 2023 as WO 2023/165673 A1 under PCT Article 21(2).

### FIELD

The present invention is directed to a device for generating or assisting a relative movement between two body parts which are connected to one another via a joint structure, the device comprising a first load-bearing structure attached to a first body part, a second load-bearing structure attached to a second body part that is pivotable relative to the first body part, and an actuator via which the first load-bearing structure is connected to the second load-bearing structure. The present invention is also directed to a system for generating or assisting a plurality of relative movements between body parts connected to one another via a joint structure with several such devices.

### BACKGROUND

Such devices are used to generate or assist a movement at the human body that would otherwise be generated by muscle power alone. When several such devices are used, they are usually referred to collectively as an exosuit or exoskeleton.

Many reasons exist for developing such suits. In addition to reducing the likelihood of work absences, which are attributable to more than 20% of illnesses of the muscular and skeletal system, such devices and systems can also be used to increase physical performance and productivity while at the same time relieving the body of heavy physical work. For injured or elderly people, or those with missing limbs, this can also significantly improve their standard of living, if necessary with the simultaneous use of appropriate prosthetics.

Various exoskeletons have accordingly been developed. These usually comprise rigid, fixed and heavy support structures that can be actuated by an electric motor to generate movement. In recent years, attempts have been made to use softer structures that adapt better to the body, however, these still tend to use electromagnetic actuators that provide movement, for example, via Bowden cables.

US 2018/0056104 A1 describes an exosuit in which a large number of elastic bands surround the limbs, thus defining a suit, while the actuation is performed by a flexible linear actuator comprising an electric motor that actuates twisted strings to change the length of the strings and thus generate a relative movement of the two limbs coupled to the actuator. Such a suit, as well as the actuating strings, are significantly more flexible than previously described rigid suits, however, the actuator still remains a rigid component so that a person wearing such a suit is still restricted in their movement.

The previously described designs therefore have the disadvantage that the user is supported in his/her defined movements, while a free movement, as with normal clothing or a kind of second skin, is not possible.

### SUMMARY

An aspect of the present invention is therefore to provide a device and a system for generating or assisting a relative movement between body parts which are connected to one another via a joint structure which supports the user as far as possible without restrictions. The present invention therefore seeks to provide a soft exoskeleton whose performance data are similar to those of human muscles and which can be produced as inexpensively as possible. The risk of injury and the restrictions on movement should be reduced and pressure points avoided when worn.

In an embodiment, the present invention provides a device for generating or assisting a relative movement between two body parts which are connected to one another via a joint structure. The device includes a first load-bearing structure which is attached to a first body part of the two body parts, a second load-bearing structure which is attached to a second body part of the two body parts, and an actuator. The second body part is pivotable relative to the first body part. The actuator connects the first load-bearing structure to the second load-bearing structure. The actuator is an electrostatic linear film actuator.

### BRIEF DESCRIPTION OF THE DRAWINGS

The present invention is described in greater detail below on the basis of embodiments and of the drawings in which:

FIG. 1 shows a side view of a principle sketch of an electrostatic film actuator;

FIG. 2 shows a device according to the present invention for generating or assisting a relative movement between two body parts which are connected to one another via a joint structure;

FIG. 3 show a first view of a system according to the present invention for generating or assisting a plurality of relative movements between body parts connected to one another via a joint structure on a body;

FIG. 4 show a second view of a system according to the present invention for generating or assisting a plurality of relative movements between body parts connected to one another via a joint structure on a body;

FIG. 5 show a third view of a system according to the present invention for generating or assisting a plurality of relative movements between body parts connected to one another via a joint structure on a body;

FIG. 6 show a fourth view of a system according to the present invention for generating or assisting a plurality of relative movements between body parts connected to one another via a joint structure on a body;

FIG. 7 show a fifth view of a system according to the present invention for generating or assisting a plurality of relative movements between body parts connected to one another via a joint structure on a body; and

FIG. 8 show a sixth view of a system according to the present invention for generating or assisting a plurality of relative movements between body parts connected to one another via a joint structure on a body.

### DETAILED DESCRIPTION

The present invention provides a device for generating or assisting a relative movement between two body parts which are connected to one another via a joint structure. The joint structure can be defined as a joint, such as a shoulder or knee joint, as well as the spine, which can, for example, be used to move the head relative to the torso or the torso relative to the hips. The term “body parts” is accordingly understood to include not only the extremities, but also the chest, head or buttocks, as well as the feet, toes, hands and fingers. The device comprises a first load-bearing structure that is attached to a first body part. A load-bearing structure is understood to be a structure that can transfer a load generated by an actuator to the body part to which it is attached. When used on humans, a large-area force distribution can be useful to avoid excessively loaded pressure and friction surfaces. There must accordingly be a connection of any kind to the actuator, directly or indirectly, and a corresponding attachment to a body part. An indirect connection is understood to be a connection that is not made directly between the two components or body parts mentioned, but rather with the interposition of a further component. The device according to the present invention also comprises a second load-bearing structure that is attached to a second body part that can be pivoted relative to the first body part, such as the thigh can be pivoted relative to the lower leg or the chest can be pivoted relative to the hip. The device also comprises an actuator via which the first load-bearing structure is connected directly or indirectly to the second load-bearing structure. According to the present invention, this actuator is an electrostatic linear film actuator. The actuator is thus arranged between the two load-bearing structures so that when the film actuator is actuated, one body part is moved relative to the other. Such a film actuator usually consists of two or more layers in which a series of conductive electrodes, configured as conductive plates or combs, are respectively arranged, which are separated by an electric insulator that can be polarized by an applied electric field. The actuation is based on the force between the two conductive electrodes when a voltage is applied between them. The arrangement of the electrodes in rows behind each other can generate a linear movement of the two layers in relation to each other by generating a continuous voltage wave in the electrodes of the first layer, which generates attractive and/or repulsive forces on the second layer, which lead to a translational movement of the second layer as the voltage in the first layer progresses in a wave-like manner. The force of such an actuator can be increased, for example, by using several layers arranged on top of each other, with every second layer being configured and supplied with current in the same way. Such a film actuator can be flexibly bent and accordingly adapts to the body when moved. This results in significantly increased wearing comfort. Such a film actuator can also generate an equally large force in both directions so that movements in both directions, i.e., bending and stretching, can be generated. These film actuators have a high power density and can be adjusted and very precisely controlled in terms of the required force. The device can of course also have a third load-bearing structure that is at least indirectly connected to the actuator. Such an additional structure can be used either for additional attachment or for applying the force to a third body part connected via a further joint. This can be useful, for example, when actuating a finger.

The present invention also provides a system for generating or assisting a plurality of relative movements between body parts which are connected to one another via a joint structure, the system having several such devices. The system comprises a hip load bearing structure located at the waist or hip to which two electrostatic film actuators are attached. A first of the thigh motion film actuators is attached at its end remote from the hip load bearing structure to a first thigh load bearing structure at the first thigh, and a second thigh movement film actuator is attached to a second thigh load-bearing structure at the second thigh with its end facing away from the hip load-bearing structure. This means that, when activated appropriately, the legs can be raised and lowered as required. The actuator with the load-bearing structures can be configured to be completely flexible or elastic so that the system can adapt to the body and still make movement of the lower body possible.

A torso load-bearing structure can additionally or independently be attached to the torso at chest height, to which two electrostatic film actuators are attached, of which a first upper arm movement film actuator is attached with its end facing away from the torso load-bearing structure to a first upper arm load-bearing structure at the first upper arm, and a second upper arm movement film actuator is attached with its end facing away from the torso load-bearing structure to a second upper arm load-bearing structure at the second upper arm. This system is also fully flexible and adapts to the user's body accordingly.

The user is not restricted in any way in both cases. The flexibility also completely eliminates pressure points.

The film actuator can, for example, comprise a stator that is at least indirectly connected to one of the two load-bearing structures and a sliding element that is at least indirectly connected to the other of the two load-bearing structures. The stator is at a constant distance from one of the load-bearing structures. The same applies to the sliding element, which is also at a constant distance from the second load-bearing structure. When current is applied, the sliding element slides along the surface of the stator, thereby shortening or lengthening the distance between the two load-bearing structures. This results in a pivoting movement around the joint arranged between the load-bearing structures.

The stator of the film actuator can, for example, be configured with first electrodes and the sliding element of the film actuator can, for example, be configured with second electrodes, wherein the first electrodes and the second electrodes can be supplied with different multi-phase alternating voltages from a control electronics system that is connected to an energy accumulator. This application of voltage causes repulsive and/or attractive forces to be generated between the first electrodes and the second electrodes, and thus between the stator and the sliding element, which, when correctly controlled, generate the linear, translational movement of the sliding element along the stator surface. The actuating speed is very high. There is also good and very precise controllability. Injuries caused by the moving elements are practically excluded since the sliding element slides directly on the stator thus avoiding jamming between moving and static parts.

The first load-bearing structure can, for example, be arranged at the first body part that is not to be moved, and the second load-bearing structure can, for example, be arranged at the second body part that is to be moved relative to the first body part, wherein a distance of the one load-bearing structure to a joint structure between the two body parts is smaller than the distance of the other load-bearing structure to the joint structure between the two body parts. The actuator thus always remains outside of the joint structure and is always close to one of the two body parts, which significantly increases wearing comfort.

In an embodiment of the present invention, the sliding element of the electrostatic film actuator can, for example, be at least indirectly connected to the second load-bearing structure and the stator of the electrostatic film actuator can, for example, be at least indirectly connected to the first load-bearing structure. The movement of the sliding element is also accordingly directly transmitted to the body part to be moved.

The stator and the sliding element can, for example, be arranged between the joint structure and one of the load-bearing structures, whereby the entire film actuator rests on a fixed body part. Interference with the movement of the actuator due to the bending that is defined is thereby reliably avoided. The actuator is instead arranged in an environment in which a largely smooth surface is usually available.

The stator can, for example, be located on the side of the respective body part to which the movement of the second body part occurs during the bending. A tensile movement is accordingly carried out by the film actuator, which can be transferred much more easily even through partially flexible bands, while the stretching movement is usually supported by the force of gravity.

The load-bearing structures can, for example, be flexible and adjustable. This means that they are comfortable to wear and can be adapted to the user, respectively, so that an optimal fit can be achieved. The adjustability can be achieved automatically by elastic materials as well as by corresponding fastening structures such as Velcro fasteners.

In an embodiment of the present invention, the load-bearing structures comprise textile bands. These are comfortable to wear, can be configured to be elastic, and are inexpensive to produce. Each load-bearing structure can comprise one or more bands.

In an embodiment of the present invention, several electrostatic linear film actuators can, for example, be connected to the two load bearing structures. The film actuators are connected in parallel. This can be used for different purposes. For example, the force required to generate the movement can simply be distributed or forces acting in different directions can be generated if the film actuators are distributed over the circumference of the load bearing structures. Opposing movements can be actuated by pulling forces, as the antagonist muscles do in the human body, and in the case of joints that allow movements in different directions, such as the shoulder joint, the movement of the upper arm can also be controlled in different directions depending on the control of the respective actuator, for example, lifting the upper arm outwards, forwards, or backwards.

In a further development of the system for generating or assisting a plurality of relative movements, the torso load-bearing structure can, for example, be connected to the hip load-bearing structure via a back movement film actuator. This provides a full-body suit that can be used to move or assist not only the extremities but also the entire torso.

An energy accumulator and control electronics can, for example, be configured on the hip load-bearing structure. The energy accumulator and electronics are usually not disruptive or restrictive to movement in this area, yet remain easily accessible.

The back movement film actuator can, for example, be located at the back between the torso load-bearing structure and the hip load-bearing structure, which means that the abdominal area can remain free so that the range of movement of the arms and legs is not restricted here either. This in particular means that a bent posture can be used to generate or assist the straightening of the upper body via a pulling movement. To prevent the hip load-bearing structure from shifting, additional leg bands can of course be provided that are firmly attached to the hip load-bearing structure.

The thigh load-bearing structure can, for example, comprise a first band at the thigh above the knee and a second band at the lower leg below the knee, which are connected to one another, wherein the thigh movement film actuators rest on the thighs. This provides that the load-bearing structure remains in place at the knee even when the leg is lifted. The film actuator remains in close proximity to the body.

The torso load-bearing structure can, for example, comprise a chest band that encloses the torso and is connected on both sides to a shoulder band that radially surrounds the shoulder joint on the torso side. This is a simple way of reliably fixing the torso load-bearing structure to the body. Slippage is thereby reliably prevented. The connection to the back movement film actuator and the upper arm movement film actuator is further simplified.

The upper arm movement film actuators are accordingly attached at least indirectly between the upper arm load-bearing structures and the torso load-bearing structure at the shoulder bands. This means that a straight-line movement can be performed without the need for deflections. This means that there is no part of the body that could hinder the movement generated when the film actuators are attached to the torso load-bearing structure.

A first underarm movement film actuator can, for example, be attached at least indirectly to the first upper arm load-bearing structure, the end of which facing away from the first upper arm load-bearing structure is attached at least indirectly to a first underarm load-bearing structure and a second underarm movement film actuator is attached at least indirectly to the second upper arm load-bearing structure, the end of which facing away from the second upper arm load-bearing structure is attached at least indirectly to a second underarm load-bearing structure. This means that the underarm can also be moved towards the upper arm or this movement can be supported.

In a further embodiment of the present invention, the first and second upper arm load-bearing structures can, for example, be arranged near the elbow joint and the first and second underarm load-bearing structures can, for example, be arranged near the wrist, so that the upper arm movement film actuators rest on the upper arms and the underarm movement film actuators rest on the underarms. This reduces the space required and prevents the actuators from jamming. The lever is at the same time used to actuate the respective body part.

Several parallel back movement film actuators can, for example, be attached to the torso load-bearing structure and the hip load-bearing structure which are distributed over the circumference of the torso load-bearing structure and the hip load-bearing structure. Distributed over the circumference does not necessarily mean evenly distributed. The actuators can, for example, be distributed according to a desired direction of movement to be actuated. One film actuator could, for example, be arranged between the load-bearing structures on each side of the body, as well as at the front and back. The upper body could then be moved or supported in all directions, i.e., sideways or forwards and backwards, via the film actuators. Mixed movements can of course also be achieved. The right actuator could, for example, be operated with the front actuator, which would result in a movement pointing diagonally to the front right.

Several parallel upper arm movement film actuators can similarly be attached to the torso load-bearing structure and the upper arm load-bearing structure, distributed around the circumference of the shoulder band and the upper arm load-bearing structure. This would allow the upper arm to be moved in all directions relative to the shoulder joint, i.e., forwards, backwards or sideways, if the film actuators are distributed over the entire circumference. It is also possible, however, to arrange several actuators next to each other and to connect them in parallel to distribute the force, wherein the force then acts in a similar direction.

Several parallel thigh movement film actuators can also be attached to the hip load-bearing structure and the thigh load-bearing structure, which are distributed over the circumference of the hip load-bearing structure and the thigh load-bearing structure, whereby movements in different directions can also here be carried out or the force of an actuator can be increased.

A device and a system for generating or assisting a relative movement between body parts connected to one another via a joint structure are thus provided which comprise only soft structures and can therefore be adapted to the body. The user therefore feels almost no restrictions in his/her usual movement and is nevertheless fully supported in all directions of movement if desired. Such a device and such a system can be used both to facilitate work and to actuate paralyzed body parts or prostheses. It is also possible to use it as a training device if a muscle counteracts the electrostatic actuation.

Several embodiments of devices according to the present invention for generating or assisting a relative movement between two body parts connected to one another via a joint structure, as well as systems according to the present invention for generating or assisting a plurality of relative movements between body parts connected to one another via a joint structure, with several such devices, are shown in the drawings and are described below.

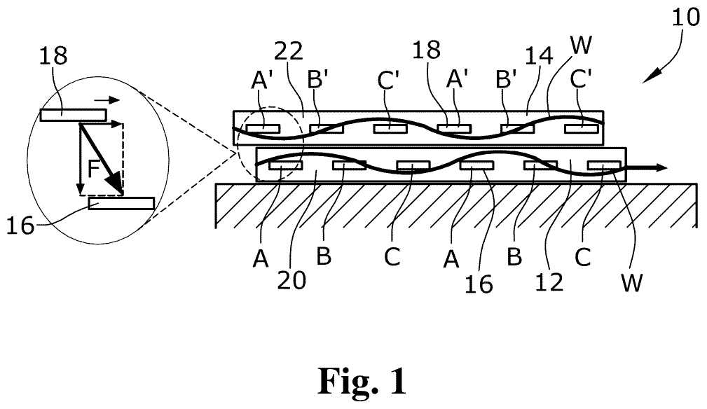

FIG. 1 shows a schematic of an electrostatic film actuator 10. This film actuator 10 consists of two completely flexible thin-film layers 12, 14, which can be made, for example, from a polyimide that serves as an insulator, and in which a large number of electrodes 16, 18 are arranged in strips one behind the other, which are connected to one another in phases. The thickness of these thin-film layers 12, 14 is in the um range.

The first thin-film layer 12 defines a stator 20 of the film actuator 10. The second thin-film layer 14 defines a sliding element 22 of the film actuator 10. A multi-phase alternating current signal is generated by a control electronics 24 and an energy accumulator 26 as a voltage source and is connected to the electrodes 16 of the stator 20 and to the electrodes 18 of the sliding element 22, whereby the electrodes 16, 18 are supplied with a multi-phase alternating voltage. Three-phase alternating voltages are accordingly applied to the electrodes 16, 18 in the present embodiment.

In greater detail, voltages are applied successively to the three phases A, B, C of the electrodes 16, 18, which are configured in a phase-shifted manner with respect to one another. When these three-phase sinusoidal voltages are applied, travelling waves W develop in the stator 20 and in the sliding element 22. The phase difference between these two travelling waves W generates an electrostatic force F between the stator 20 and the sliding element 22, thereby causing the sliding element 22 to move along the stator 20 when the stator 20 is held in place. A translationally effective film actuator 10 is accordingly provided.

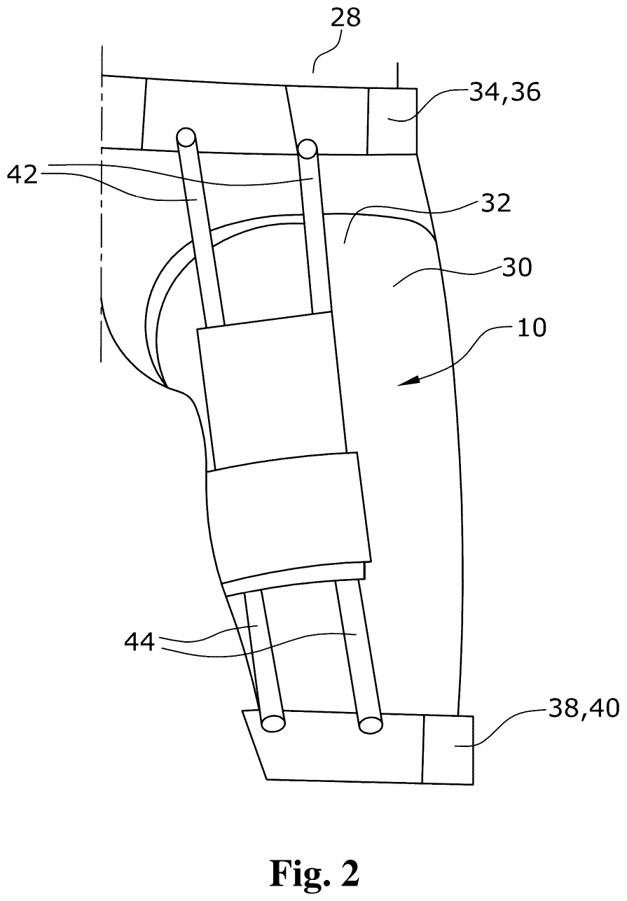

FIG. 2 shows such an electrostatic film actuator 10 in its use according to the present invention as a device for generating or assisting a relative movement between two body parts 28, 30 which are connected to one another via a joint structure 32.

A first load-bearing structure 34 comprising a textile first band 36 is attached to the first body part 28. A second load-bearing structure 38 is attached to the second body part 30, which is to be moved relative to the first body part 28, the second load-bearing structure 38 also comprising a textile second band 40 that circumferentially surrounds the second body part 30.

The first load-bearing structure 34, or the first band 36 surrounding the first body part 28, is connected to the stator 20 of the film actuator 10 via two fastening elements 42.

The second load-bearing structure 38, or the second band 40 surrounding the second body part 30, is also connected to the sliding element 22 of the film actuator 10 via two such fastening elements 44. The fastening elements 42, 44 are respectively attached on both sides of the film actuator 10 at the stator 20 and at the sliding element 22 and comprise a length which is chosen so that, in the non-actuated state of the film actuator 10, the fastening elements 44 are tensioned between the bands 36, 40 and the stator 20 and the sliding element 22, respectively. In this state, the film actuator 10 lies flat on the second body part 30 that is to be moved.

When the film actuator 10 is operated in the manner described above, the sliding element 22 is displaced on the stator 20. This results in a forced shortening of the distance between the two load-bearing structures 34, 38, which causes a force to be exerted via the load-bearing structures 34, 38 on the body parts 28, 30 that can be moved relative to one another, thereby causing a movement of the second body part 30 relative to the first body part 28 so that the second body part 30 pivots about the joint structure 32 towards the first body part 28 and thus into a position in which the two load-bearing structures 34, 38 are at a correspondingly smaller distance from each other.

The first band 36 is arranged as close as possible to the joint structure 32, while the second band 40 at the second body part 30 is as far away as possible, thereby providing that during the entire movement the film is located between the second band 40 and the joint structure 32, and thus does not enter the area in the immediate vicinity of the joint structure 32, which becomes increasingly narrow as the movement continues. The stator 20 instead remains in the immediate vicinity of the second body part 30 or can rest thereon.

Depending on the location at which the stator 20 or the sliding element 22 is attached to the load-bearing structures 34, 38, the location at which the force is applied and thus the direction of the effective torque can also be changed so that different directions of movement can also be generated in the case of joint structures 32 without a fixed axis of rotation, depending on how the film actuator 10 is attached to the load-bearing structures 34, 38.

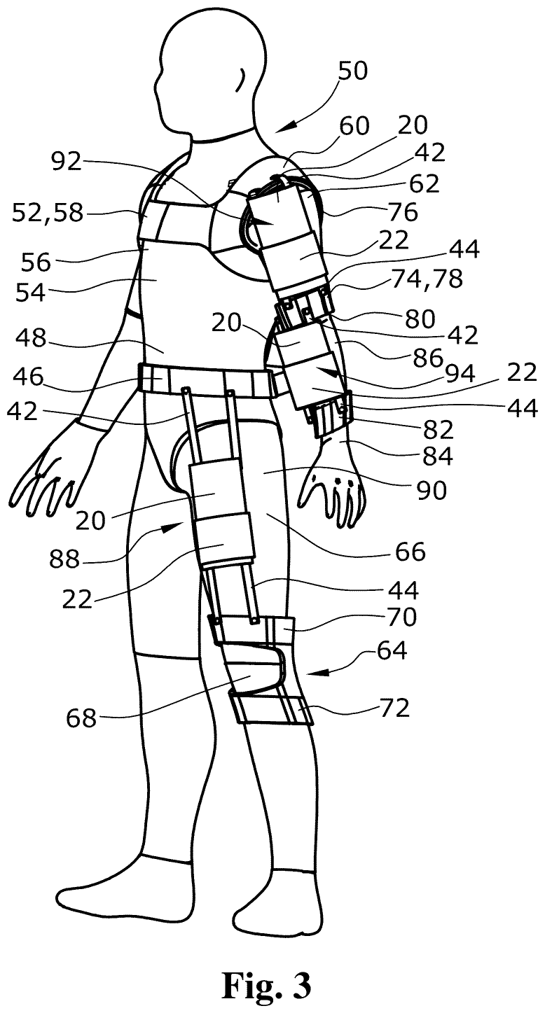

FIGS. 3 to 8 show a system that is made up of a plurality of such devices according to the present invention.

The system consists of a hip load-bearing structure 46 that is attached to the hip or waist 48 of the user 50, a torso load-bearing structure 52 that is attached to a torso 54 in the area a chest 56, and a chest band 58 which surrounds the chest 56 of the user 50 and shoulder bands 60 attached thereto which surround shoulder joints 62 of the user 50 on the torso side.

This system further comprises two thigh load-bearing structures 64, of which only one is shown in FIGS. 3 to 8 for the sake of clarity, wherein the second thigh load-bearing structure 64 is to be arranged symmetrically to the first on the other thigh 66 or knee 68. This consists of a first band 70, which is arranged above a knee 68 of the user 50 at the thigh 66, and a second band 72, which is arranged below the knee 68 at the lower leg 69 for better stability, wherein the two bands 70, 72 are connected to one another at the back, as in a knee bandage.

The system also consists of two upper arm load-bearing structures 74, of which only one is shown in the drawings for the sake of clarity, with the second upper arm load-bearing structure 74 being arranged symmetrically on the other upper arm 76. This comprises a band 78, which is arranged above an elbow joint 80 of the user 50 at the upper arm 76.

Two further underarm load-bearing structures 82 are attached to the two underarms 86 near the wrists 84.

FIG. 3 shows that an electrostatic thigh movement film actuator 88 is connected to the hip load-bearing structure 46 and the thigh load-bearing structure 64, wherein the hip load-bearing structure 46 comprises the connection to the stator 20 and the thigh load-bearing structure 64 comprises the connection to the sliding element 22 of the thigh movement film actuator 88.

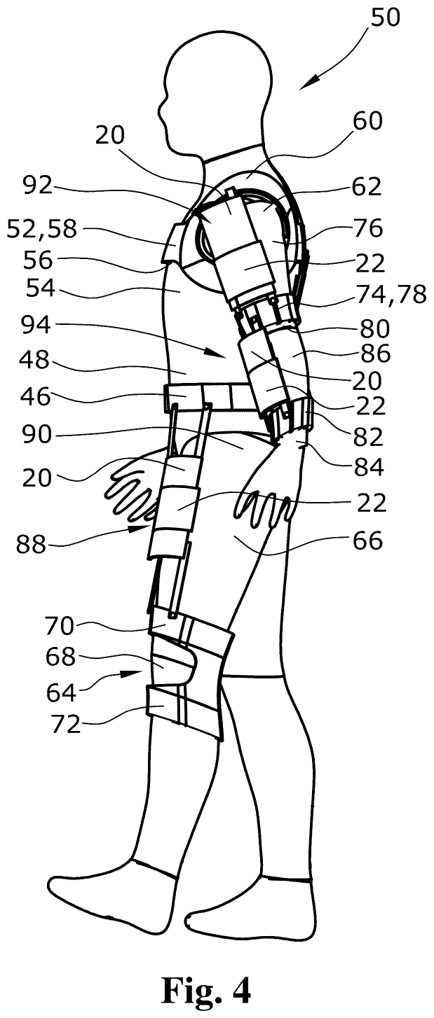

When the thigh movement film actuator 88 is energized, the sliding element 22 is displaced on the stator 20, as can be seen in FIG. 4 in comparison to FIG. 3. The thigh 66 is correspondingly rotated upwards by a hip joint 90 since the distance between the load-bearing structures 46, 64 is shortened. A step can be generated in the same way.

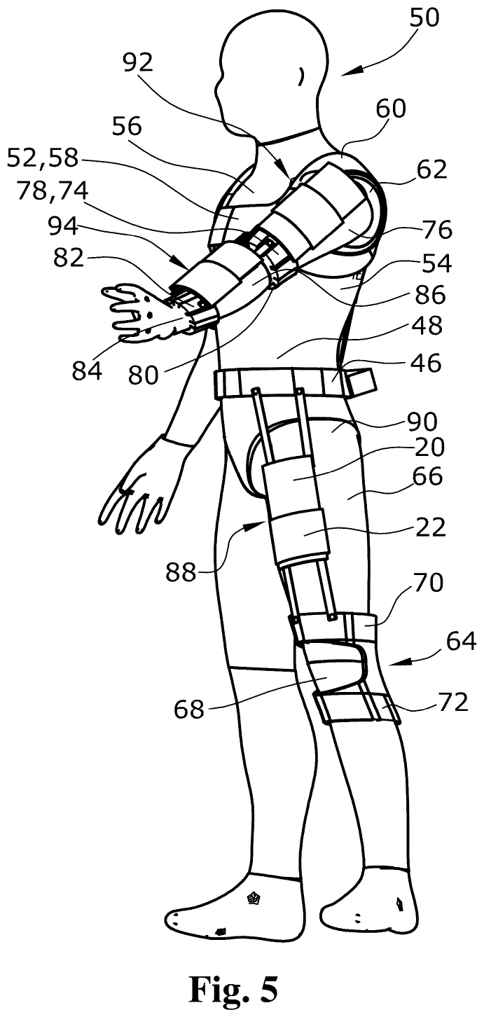

An electrostatic upper arm movement film actuator 92 is arranged between the shoulder band 60, the torso load-bearing structure 52, and the upper arm load-bearing structure 74, the stator 20 of which is connected to the shoulder band 60 of the torso load-bearing structure 52 via the fastening structures 42 to the shoulder band 60 of the torso load-bearing structure 52 and whose sliding element 22 is connected to the upper arm load-bearing structure 74 via the fastening structures 44. When the upper arm movement film actuator 92 is activated, the sliding element 22 again moves on the stator 20, as can be seen in FIG. 5, thus shortening the distance between the connection points of the two connected load-bearing structures 52, 74, causing the upper arm 76 to rotate around the shoulder joint 62 and thus to be raised.

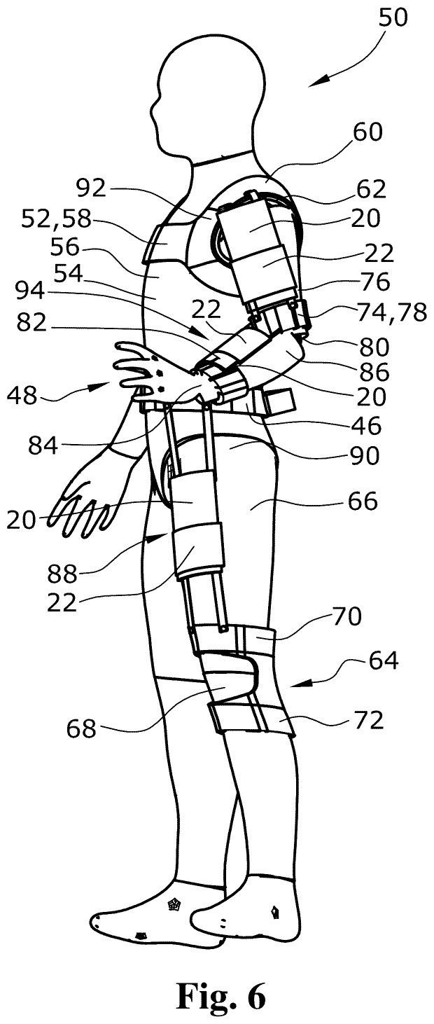

FIG. 6 shows the corresponding movement of the underarm 86, i.e., its rotation around the elbow joint 80, which is generated by an electrostatic underarm movement film actuator 94 being stretched between the upper arm load-bearing structure 74 and the underarm load-bearing structure 82. The stator 20 is here also attached to the upper arm load-bearing structure 74, which is located closer to the elbow joint 80, just as the stators 20 of the other film actuators 88, 92, 94 are attached to the load-bearing structures that are located closer to the joint structures 62, 80, 90. It can furthermore be seen that the film actuators 88, 92, 94 are respectively arranged on the side of the body part to which the body part is to be moved. Pulling forces are thus always transmitted.

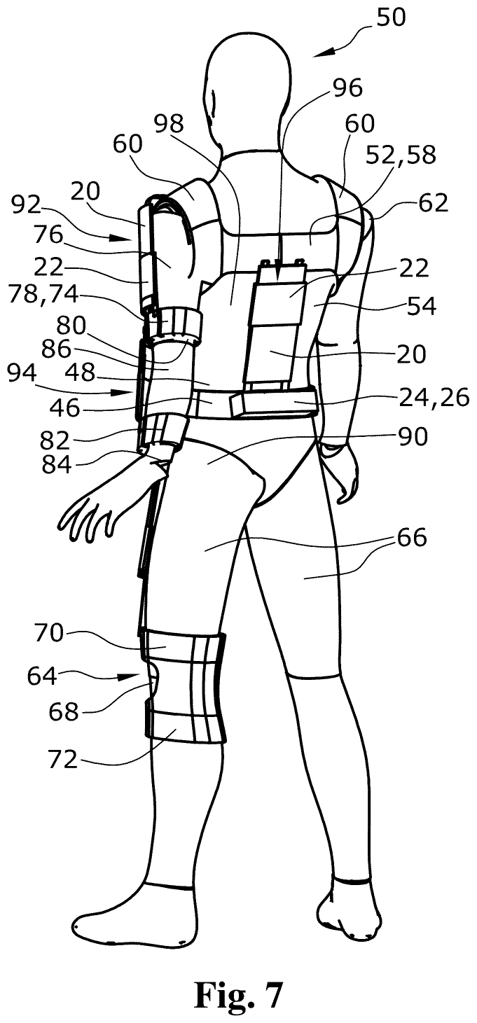

FIG. 7 also shows a back movement film actuator 96, which is attached to the back 98 of the user 50 and whose stator 20 is attached to the chest band 58 of the torso load-bearing structure 52 and whose sliding element 22 is attached to the hip load-bearing structure 46. This back movement film actuator 96 is used primarily to support or to carry out lifting movements and thus to straighten the back from a bent position. For this reason, the sliding element 22 is also in its raised upper position in FIG. 7. The energy accumulator 26 and the control electronics 24 are furthermore attached to the hip load-bearing structure 46.

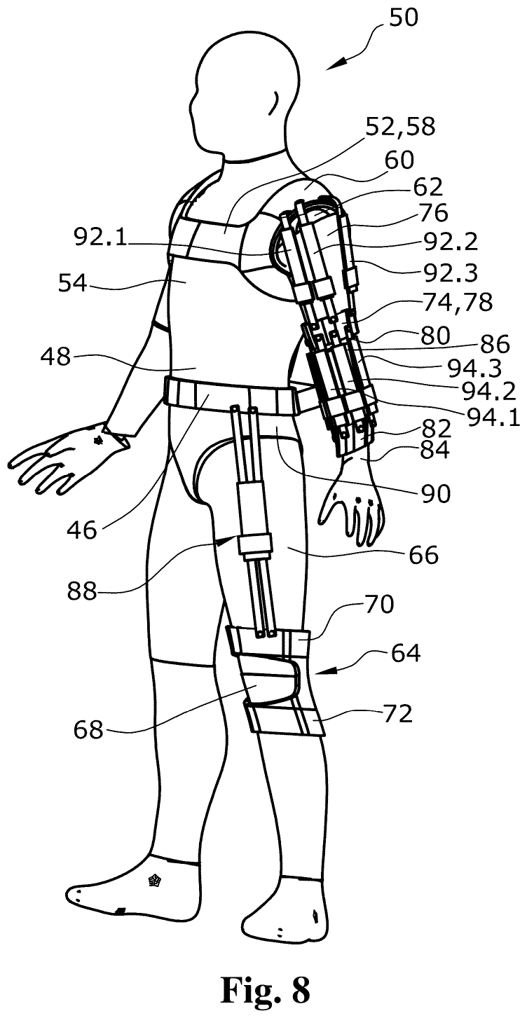

A further embodiment of the system according to the present invention is shown in FIG. 8. The individual large electrostatic upper arm movement film actuators 92 and underarm movement film actuators 94 are here replaced by several small upper arm movement film actuators 92 and underarm movement film actuators 94. This can either be used to distribute the force to be applied to several film actuators 92, 94 or the film actuators 92, 94 can all be controlled individually so that complex movements can be performed. To do this, the film actuators 92, 94 are distributed over the circumference of the load-bearing structures 52, 74, 82 so that they act in different directions when current is applied. The upper arm 76 can, for example, be raised around the shoulder joint 62 either forwards, backwards or sideways. This can be provided by a front upper arm movement film actuator 92.1, a lateral upper arm movement film actuator 92.2, and a rear upper arm movement film actuator 92.3. Additional film actuators are of course also conceivable.

The devices and systems described for generating or assisting a relative movement between two parts of the body connected to one another via a joint structure make it possible to generate or at least assist a precisely controllable movement in a simple manner. The actuators and attachment structures used are flexible and therefore offer a high level of comfort, which only limits the user to a very small extent. The use of many smaller actuators can also achieve a very high degree of flexibility in terms of movement so that a natural sequence of movements can be supported or adjusted.

It should be clear that the present invention is not limited to the described embodiments. The system can of course also comprise more actuators, for example, at the lower leg or feet, but also at the hands or abdomen. In comparison to the embodiment described, actuators and load-bearing structures can also be omitted. The load-bearing structures can also be made of other materials and have other shapes. The only decisive factor here is that the force can be transferred from the film actuator to the respective part of the body. Force transmission paths via Bowden cables or similar are in principle also conceivable. It should also be noted that the film actuators can also comprise several stator layers and sliding element layers that are connected in parallel which can increase the electrostatic force. Various other body parts can also be controlled via several film actuators. This is particularly useful at all joints that allow different directions of movement, such as the back, shoulder joint, head joint, hip joint or elbow. The energy accumulator can, of course, also be attached to other positions on the structure depending on the embodiment of the device or the system itself. It should also be noted that the movements to be generated can always be generated on both sides, i.e., the actuators can act as agonists as well as antagonists.

The present invention is not limited to embodiments described herein; reference should be had to the appended claims.

### LIST OF REFERENCE CHARACTERS

10 Film actuator
12 First thin-film layer
14 Second thin-film layer
16 Electrodes
18 Electrodes
20 Stator
22 Sliding element
24 Control electronics
26 Energy accumulator
28 First body part
30 Second body part
32 Joint structure
34 First load-bearing structure
36 First band
38 Second load-bearing structure
40 Second band
42 Fastening element
44 Fastening element
46 Hip load-bearing structure
48 Waist
50 User
52 Torso load-bearing structure
54 Torso
56 Chest
58 Chest band
60 Shoulder band
62 Shoulder joint
64 Thigh load-bearing structure
66 Thigh
68 Knee
70 First band
72 Second band
74 Upper arm load-bearing structure
76 Upper arm
78 Band
80 Elbow joint
82 Underarm load-bearing structure
84 Wrist
86 Underarm
88 Thigh movement film actuator
90 Hip joint
92 Upper arm movement film actuator
92.1 Front upper arm movement film actuator
92.2 Lateral upper arm movement film actuator
92.3 Rear upper arm movement film actuator
94 Underarm movement film actuator
94.1 First underarm movement film actuator
94.2 Second underarm movement film actuator
94.3 Third underarm movement film actuator
96 Back movement film actuator
A Phase
A′ Phase
B Phase
B′ Phase
C Phase
C′ Phase
F Electrostatic force
W Travelling waves

What is claimed is:

1-24. (canceled)

25. A device for generating or assisting a relative movement between two body parts which are connected to one another via a joint structure, the device comprising:
a first load-bearing structure which is attached to a first body part of the two body parts;
a second load-bearing structure which is attached to a second body part of the two body parts, the second body part being pivotable relative to the first body part; and
an actuator which connects the first load-bearing structure to the second load-bearing structure,
wherein,
the actuator is an electrostatic linear film actuator.

26. The device as recited in claim 25, wherein the electrostatic linear film actuator comprises,
a stator which is at least indirectly connected to one of the first load-bearing structure and the second load-bearing structure, and
a sliding element which is at least indirectly connected to the other one of the first load-bearing structure and the second load-bearing structure.

27. The device as recited in claim 26, further comprising:
an energy accumulator; and
a control electronics which is connected to the energy accumulator,
wherein,
the stator comprises first electrodes arranged therein,
the sliding element comprises second electrodes arranged therein, and
each of the first electrodes and the second electrodes are configured to be suppliable with different multi-phase alternating voltages from the control electronics which is connected to the energy accumulator.

28. The device as recited in claim 26, wherein,
the sliding element of the electrostatic linear film actuator is at least indirectly connected to the second load-bearing structure, and
the stator of the electrostatic linear film actuator is at least indirectly connected to the first load-bearing structure.

29. The device as recited in claim 26, wherein the stator and the sliding element of the electrostatic linear film actuator are each arranged between the joint structure and one of the first load-bearing structure and the second load-bearing structure.

30. The device as recited in claim 26, wherein the stator of the electrostatic linear film actuator rests completely on the first body part or on the second body part.

31. The device as recited in claim 26, wherein the stator of the electrostatic linear film actuator rests on a side of one of the first body part and the second body part towards which a movement of the second body part is effected.

32. The device as recited in claim 25, wherein,
the first load-bearing structure is arranged at the first body part which is not to be moved,
the second load-bearing structure is arranged at the second body part which is to be moved relative to the first body part, and
a distance of the one of the first load-bearing structure and the second load-bearing structure to the joint structure between the two body parts is smaller than a distance of the respectively other one of the first load-bearing structure and the second load-bearing structure to the joint structure between the two body parts.

33. The device as recited in claim 25, wherein each of the first load-bearing structure and the second load-bearing structure are flexible and adjustable.

34. The device as recited in claim 25, wherein,
the first load-bearing structure comprises a textile band, and
the second load-bearing structure comprises a textile band.

35. The device as recited in claim 25, further comprising:
a plurality of the electrostatic linear film actuator, and
wherein,
the plurality of the electrostatic linear film actuators are connected to the first load-bearing structure and to the second load-bearing structure.

36. A system for generating or assisting a plurality of relative movements between body parts which are connected to one another via a joint structure, the system comprising:
a plurality of the device as recited in claim 25;
a hip load bearing structure which is arranged at a waist or at a hip;
two electrostatic thigh movement film actuators which are attached to the hip load bearing structure, the two electrostatic thigh movement film actuators comprising a first thigh movement film actuator and a second thigh movement film actuator;
a first thigh load bearing structure attached at a first thigh; and
a second thigh load bearing structure attached at a second thigh,
wherein,
an end of the first thigh movement film actuator which faces away from the hip load bearing structure is attached to the first thigh load bearing structure at the first thigh, and
an end the second thigh movement film actuator is which faces away from the hip load bearing structure attached to the second thigh load bearing structure at the second thigh.

37. The system as recited in claim 36, wherein,
each of the first thigh load bearing structure and the second thigh load bearing structure comprises a first band at the thigh above a knee, and a second band at a lower leg below the knee,
the first band is connected to the second band, and
the first thigh movement film actuator rests on the first thigh, and
the second thigh movement film actuator rests on the second thigh.

38. The system as recited in claim 36, further comprising:
an energy accumulator which is arranged on the hip load-bearing structure; and
a control electronics which is arranged on the hip load-bearing structure.

39. The system as recited in claim 36, further comprising:
a torso load bearing structure which is attached to the torso at a chest height;
two electrostatic upper arm movement film actuators which are attached to the torso load bearing structure, the two electrostatic upper arm film actuators comprising a first upper arm movement film actuator and a second upper arm movement film actuator;
a first upper arm load bearing structure which is attached at a first upper arm; and
a second upper arm load bearing structure which is attached at a second upper arm,
wherein,
an end of the first upper arm movement film actuator which faces away from the torso load bearing structure is attached to the first upper arm load bearing structure at the first upper arm, and
an end of the second upper arm movement film actuator which faces away from the torso load bearing structure is attached to the second upper arm load bearing structure at the second upper arm.

40. The system as recited in claim 39, further comprising:
a back movement film actuator;
wherein,
the torso load-bearing structure is connected to the hip load-bearing structure via the back movement film actuator.

41. The system as recited in claim 40, further comprising:
a plurality of the back motion film actuator which are arranged in parallel,
wherein,
the plurality of the back motion film actuators are each attached to the torso load bearing structure and to the hip load bearing structure, and
the plurality of the back motion film actuators are each distributed around a circumference of the torso load bearing structure and of the hip load bearing structure.

42. The system as recited in claim 40, wherein the back movement film actuator is arranged on a back between the torso load-bearing structure and the hip load-bearing structure.

43. The system as recited in claim 39, wherein the torso load-bearing structure comprises,
a first shoulder band which radially surrounds a first shoulder joint on a first torso side,
a second shoulder band which radially surrounds a second shoulder joint on a second torso side, and
a chest band which is configured to enclose the torso and to be connected on the first torso side to the first shoulder band and on the second torso side to the second shoulder band.

44. The system as recited in claim 43, wherein,
the first upper arm movement film actuator comprises a plurality upper arm motion film actuators which are arranged in parallel, each of the plurality upper arm motion film actuators being attached to the torso load bearing structure and to the first upper arm load bearing structure, and each of the plurality upper arm motion film actuators being distributed around a circumference of the first shoulder band and of the first upper arm load bearing structure, and
the second upper arm movement film actuator comprises a plurality upper arm motion film actuators which are arranged in parallel, each of the plurality upper arm motion film actuators being attached to the torso load bearing structure and to the second upper arm load bearing structure, and each of the plurality upper arm motion film actuators being distributed around a circumference of the second shoulder band and of the second upper arm load bearing structure.

45. The system as recited in claim 43, wherein,
the first upper arm movement film actuator is at least indirectly attached to the first shoulder band between the first upper arm load bearing structure and the torso load-bearing structure, and
the second upper arm movement film actuator is at least indirectly attached to the second shoulder band between the second upper arm load bearing structure and the torso load-bearing structure.

46. The system as recited in claim 39, further comprising:
a first underarm load-bearing structure;
a first underarm movement film actuator which is at least indirectly attached to the first upper arm load-bearing structure, an end of the first underarm movement film actuator which faces away from the first upper arm load-bearing structure being at least indirectly attached to the first underarm load-bearing structure,
a second underarm load-bearing structure, and
a second underarm movement film actuator which is at least indirectly attached to the second upper arm load-bearing structure, an end of the second underarm movement film actuator which faces away from the second upper arm load-bearing structure being at least indirectly attached to the second underarm load-bearing structure.

47. The system as recited in claim 46, wherein.
the first upper arm load bearing structure is arranged near a first elbow joint,
the second upper arm load bearing structure is arranged near a second elbow joint,
the first underarm load bearing structure is arranged near a first wrist joint so that the first upper arm motion film actuator rest on the first upper arm and the first underarm motion film actuator rests on a first underarm, and
the second underarm load bearing structure is arranged near a second wrist joint so that the second upper arm motion film actuator rests on the second upper arm and the second underarm motion film actuator rests on a second underarm.

48. The system as recited in claim 36, wherein,
the first thigh movement film actuator comprises a plurality of thigh motion film actuators which are arranged in parallel, the plurality of thigh motion film actuators being attached to the hip load bearing structure and to the first thigh load bearing structure, and the plurality of thigh motion film actuators being distributed around a circumference of the hip load bearing structure and of the first thigh load bearing structure, and
the second thigh movement film actuator comprises a plurality of thigh motion film actuators which are arranged in parallel, the plurality of thigh motion film actuators being attached to the hip load bearing structure and to the second thigh load bearing structure, and the plurality of thigh motion film actuators being distributed around a circumference of the hip load bearing structure and of the second thigh load bearing structure.
